(19) United States
(12) Patent Application Publication
(10) Pub. No.: US 2017/0168881 A1
(43) Pub. Date: Jun. 15, 2017

(54) PROCESS CHAIN DISCOVERY ACROSS COMMUNICATION CHANNELS

(71) Applicant: SAP SE, Walldorf (DE)

(72) Inventor: Sasan Memar-Zahedani, Bammental (DE)

(21) Appl. No.: 14/963,890

(22) Filed: Dec. 9, 2015

(51) Int. Cl. G06F 11/07; G06F 17/30

(52) U.S. Cl. CPC G06F 11/079; G06F 17/30867; G06F 11/0709; G06F 11/0751; G06F 11/0787; G06F 11/0772

(57) ABSTRACT

A context identifier associated with an initial application program executed during an online session of a user is used to search data sources for data records associated with the user and/or the online session. Data records that are relevant to the context identifier are collected and analyzed to log all communication protocols involved during the online session. A protocol-specific monitoring tool is selected to examine each of the collected data records based on the logged communication protocols associated with each examined data record. Each examined data record is compared to reference data to identify function errors or low component performance experienced during the online session. A process chain for the online session may be constructed by parsing a first examined data record to identify specific data record elements and mapping the first examined data record to one or more second examined data records based on the identified data record elements.

### TECHNICAL FIELD

The present disclosure relates generally to the discovery of a process chain associated with an online session of a user. In an example embodiment, after determining which program has initiated the process chain, any used communication protocols are logged in order to determine the flow of messages between separate user sessions by using appropriate protocol-specific monitoring tools.

### BACKGROUND

Analyzing specific data records, or data items (e.g., email, business documents, etc.) in isolation can lead to errors that occur because of a lack of context. Typically, an analysis of specific data is more useful to a user if it is in context of other related data, especially if the specific data and the related data are part of a same process chain (e.g., associated with a user session or a particular project). For example, several users may connect over a network. Each connection of a user to the network (and/or each use of a particular business process application over the network) may be considered a session. Some applications will interact with one another over the network, thereby creating a collaborative user environment, where various user sessions communicate and/or exchange messages between one another. The session communications can involve various clients (e.g., applications) and servers that connect such clients.

In this situation, consider an administrator who is analyzing an online business scenario (e.g., an online collaboration or transaction) initiated during a particular user session, and he/she has several data records associated with different aspects of the user and the online session, as well as several data records associated with other users and their respective online sessions. If the administrator is analyzing a specific data record associated with the online business scenario, it would be advantageous to have knowledge of which of the other data records are contextually related (e.g., part of the same online business scenario) to the specific data record under analysis.

### BRIEF DESCRIPTION OF DRAWINGS

The present disclosure is illustrated by way of example and not limitation in the figures of the accompanying drawings, in which like references indicate similar elements and in which:

FIG. 1 is a use-case diagram showing a system. consistent with some embodiments, configured to discover a process chain for a user session including user communications with other user sessions.

FIG. 2 is a use-case diagram of data flows, consistent with some embodiments, for messages between users via multiple user sessions and across distinct communication channels.

FIG. 3 is a block diagram of a process chain discovery system, consistent with some embodiments, configured to discover a process chain for a user session that includes communications with other user sessions across distinct communication channels.

FIGS. 4A, 4B, and 4C are example data records and data record elements, consistent with some embodiments, in the form of database tables.

FIG. 5 is an example graphical display of a process chain for a user session, consistent with some embodiments, for viewing and analysis by an administrative user.

FIG. 6 is a flow diagram of a method, consistent with some embodiments, for discovering function errors or low component performance during a user session that includes communications with other user sessions across distinct communication channels.

FIG. 7 is a flow diagram of a method, consistent with some embodiments, for discovering a process chain for a user session that includes communications with other user sessions across communication channels.

FIG. 8 is a diagrammatic representation of machine, in the example form of a computer system, within which a set of instructions may be executed to cause the machine to perform the methodologies discussed herein.

FIG. 9 is a block diagram illustrating a mobile device, according to an example embodiment.

### DETAILED DESCRIPTION

Embodiments described herein provide for automatically discovering a process chain associated with a user session that involves communications with other user sessions by collecting a variety of data records (e.g., statistical data), from associated data sources (e.g., communication servers), that may be relevant to the user session. The collected data records may then be used for functional logging (e.g., find errors in a specific layer of an end to end scenario) so that a user may limit an analysis to a specific part of a process chain to find the root cause of a problem more quickly. Furthermore, performance logging is also possible (since statistical data records may be collected) by focusing on data records of specific processes to determine sources with long processing times. A specific monitoring tool can be selected to analyze the performance problem based on the nature of a process that the data record is associated with. In this way, system administrators or business application developers can have a simple way to analyze a problem without having to resort to help from developers for their analysis. Corresponding error messages may be displayed (for the function errors and low performance elements) to a system administrator via a suitable display device.

In order to identify process chains (e.g., identify a complex business scenario) and show all relevant used system properties (e.g., components, processes, communication protocols, etc.), a first data record associated with an initial application that launched the user session may be parsed to identify specific data record elements. These specific data record elements may include data such as a user identifier, a session identifier, an application context identifier and/or a connection identifier identifying peers in a connection. The specific data record elements may be used perform searches over various data sources. For example, the searching can be based on a root context identifier discovered when parsing the first data record. The data records may be of various different content types and may be from various data different sources (e.g., different application servers). For example, the online process chain may be discovered, in part, by searching for varied data records that include a context identifier and/or a connection identifier that is propagated by the initial application program from one system component to the next (e.g., from a sending message client to a messaging server and on to a receiving message client).

An embodiment of the online user session process chain discovered by disclosed systems may include a sequence of used system elements and/or elements that are otherwise interacted with such as a: communication protocol; communication sub-protocol; application name; application state; business scenario; or hardware component. A graphical image of the sequence may be provided to a system administrator via a suitable display.

An embodiment provides for mapping a first data record to one or more second examined data records based on an identified first data record element comprising a connection identifier that identifies a connection between a communication component (e.g., client device) associated with the first data record (e.g., send action record) and a communication component (e.g., server device) associated with the one or more second examined data records (receive action data records). Each of the one or more second examined data records may then be similarly mapped to one or more third examined data records based on an identified second data record element comprising a connection identifier that identifies a connection between a communication component associated with the second data record and a communication component associated with the one or more third examined data records.

Embodiments may be implemented with respect to any type of data processing and messaging system. For example, an embodiment may be implemented in a system using advanced business application programming ((ABAP) as developed by SAP AG, Walldorf, Germany) sessions, and/or any other types of sessions. In this case, the at least one found data record may include: a remote function call (RFC) data record, a hypertext transfer protocol (HTTP) data record, an advanced business application programming messaging channel (AMC) data record or an advanced business application programming push channel (APC) data record, or a combination of these types of data records.

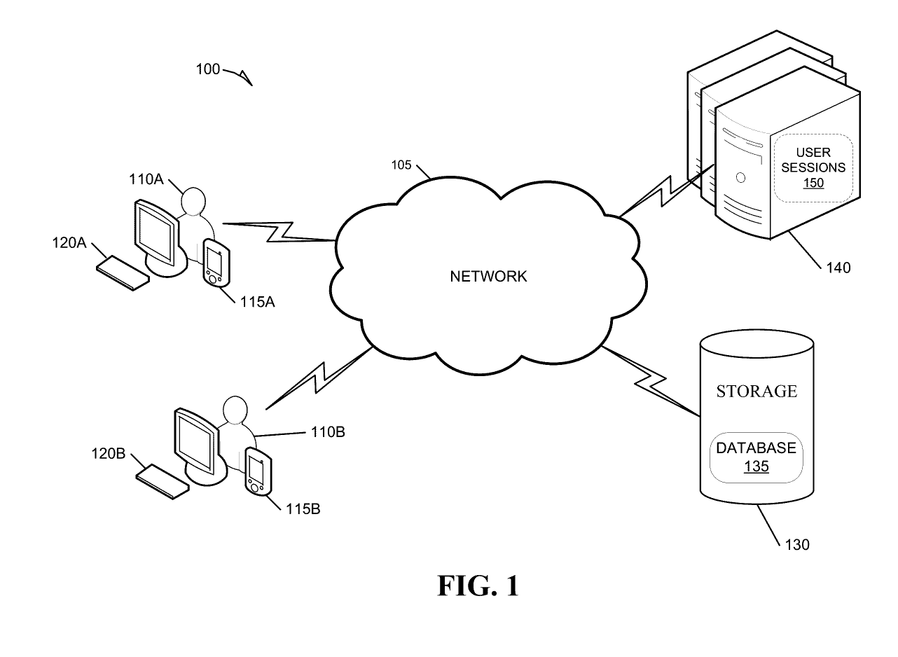

FIG. 1 is a use-case diagram showing a system 100, consistent with some embodiments, configured to discover a process chain for a user session of user 110A including user communications with other user sessions (e.g., of user 110B). System 100 includes a network 105 that can be any medium used to provide communications links between various devices (e.g., storage) and computers connected together within the system 100. Network 105 may include connections, such as wired, wireless communication links, fiber optic cables, or the like. In the depicted example, network 105 may include the Internet. Of course, network 105 may also be implemented as a number of different types of networks, such as for example, an intranet, a local area network (LAN), or a wide area network (WAN). Multiple servers 140 are connected to network 105 along with one or more storages, such as storage 130 with database 135. In addition, client devices 115A, 115B, 120A and 120B of users 110A and 110B are also connected to network 105. Client devices 120A and 120B may be, for example, personal computers (PCs) or network computers. Client devices 115A, 115B may be, for example, mobile computers, smart phones, personal digital assistants (PDAs) or other such mobile devices.

System 100 may be used for implementing a client-server environment in which described embodiments may be implemented. A client-server environment enables software applications and data to be distributed across a network such that an application functions by using the interactivity between a client data processing system and a server data processing system. In this regard, an application user interface running on client device 120A would include a server-side component (e.g., user session 150) in one or more of servers 140. Various user sessions may communicate and/or exchange messages between one another via various clients (e.g., client device 120A) and servers 140 that connect such clients.

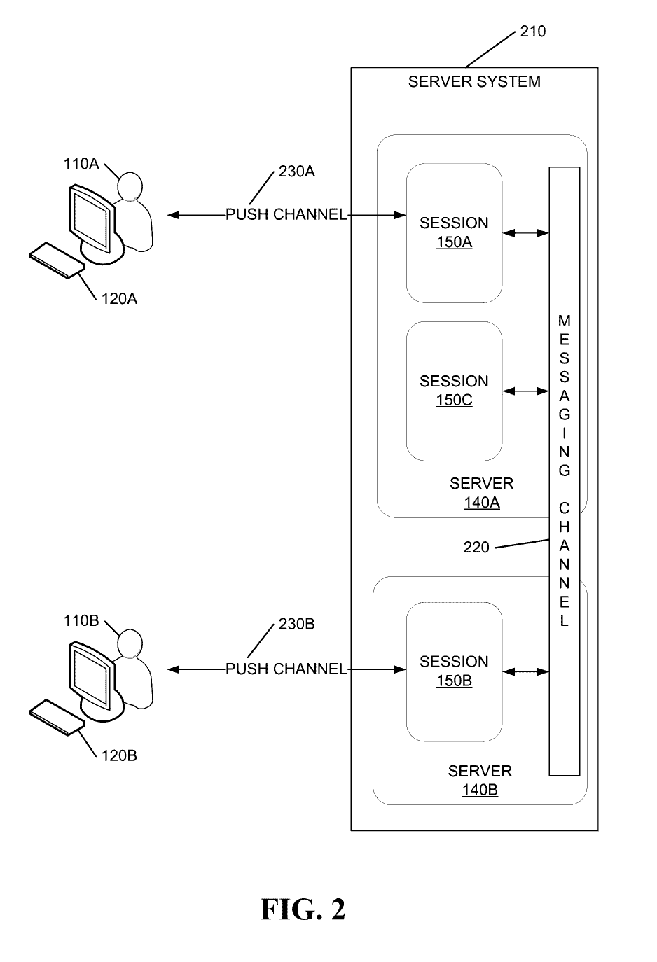

Servers 140 may act as an intermediaries (as explained below with respect to FIG. 2) for messages between user sessions 150 of applications running on separate client devices (e.g., 120A and 120B) via multiple communication channels. Embodiments described herein provide for automatically discovering a process chain associated with a first user session 150 of user 110A that involves communications with other user sessions 150 by collecting a variety of data records (e.g., statistical data records), from associated data sources (e.g., communication servers 140), that may be relevant to the first user session 150. The collected data records may be stored in a storage 130 (e.g., in a database 135) for further analysis. The collected data records may then be analyzed to find function errors (e.g., message not sent) in a specific part of a process chain so that an administrative user may limit an analysis to that specific part of the process chain. Furthermore, performance logging (e.g., a server 140 is slow for a specific process compared to reference data for that server 140) is also possible (since statistical data records may be collected) by focusing on data records of the specific process to determine sources with long processing times. A specific monitoring tool (e.g., process specific or protocol specific) can be selected to analyze the performance problem based on the nature of a process or protocol that the data record is associated with. In this way, system administrators or business application developers for system 100 can have a simple way to analyze a problem without having to resort to help from developers. Corresponding error messages may be displayed (for the function errors and low performance elements) to a system administrator via a suitable display of a client device (e.g., 120A or 115A).

According to an embodiment of system 100, in order to identify process chains (e.g., identify a complex business scenario) and show all relevant used system 100 properties (e.g., components, processes, communication protocols, etc.), a first data record associated with an initial application of client device 120A that launched the first user session 150 of user 110A may be parsed to identify specific data record elements. These specific data record elements may include data such as a user identifier for user 110A, a session identifier for the first user session 150, an application context identifier for the application of client device 120A that launched the first user session 150, and/or a connection identifier identifying peers in a connection such as client device 120A and 120B. The parsed data record elements may be used to perform searches for more related data records from each of the servers 140. The searched data records may be of various different content types and may be discovered, for example, by searching for data records that include a context identifier and/or a connection identifier that is propagated by the initial application program from one component of system 100 to the next (e.g., from a sending message client device 120A to a messaging server 140 and on to a receiving message client device 120B).

FIG. 2 is a use-case diagram of data flows, consistent with some embodiments, for messages between users 110A and 110B via multiple respective user sessions 150 and across distinct communication channels. The elements in FIG. 2 include elements from system 100 in FIG. 1 and are labeled with the same identifiers.

A user 110A of client device 120A may execute an application (e.g., user interface of a browser application) that can communicate with another application (e.g., another browser application) of another user 110B of client device 120B via a server system 210. The browser applications may be hypertext markup language (HTML) browsers or can be any other client applications that communicate. The server system 210 can include an application server 140A and an application server 140B that can communicate with one another. In some implementations, the server system 210 can include a firewall between itself and the client devices to protect itself. The applications running on client devices 120A and 120B can be, for example, user agents, WebSocket clients, browsers, client programs, any other agents, and/or any combination of agents.

The application server 140A can include user session 150A and user session 150C. The session 150A can access a push channel 230A (e.g., an ABAP push channel) and a messaging channel 220 (e.g., an ABAP messaging channel). The user session 150C can also access the messaging channel 220. The user session 150A and the user session 150C may communicate using the messaging channel 220. The client device 120A may receive notifications from the push channel 230A. These notifications may include message data which was received from the messaging channel 220 via the user session 150A (for example, from user session 150C).

The application server 140B can include user session 150B of user 110B of client device 120B. The user session 150B can access a push channel 230B and the messaging channel 220. Client device 120B can receive notifications from the push channel 230B. These notifications may include message data which was received from the messaging channel 220 via the user session 150B (for example, from user session 150A). The server 140A and the server 140B can communicate via the messaging channel 220.

The push channel 230A and push channel 230B (and any other push channels) may implement a WebSocket protocol to establish a bi-directional communication between the client device 120A and server 140A and between the client device 120B and the server 140B, respectively. Exchanging of messages can include at least one of the following: an exchanging of messages during an APC communication between an APC client and a server, an exchanging of messages during an AMC communication between user sessions, and an exchanging of messages during a communication between an APC client and an AMC messaging channel session by connecting an AMC to and APC client.

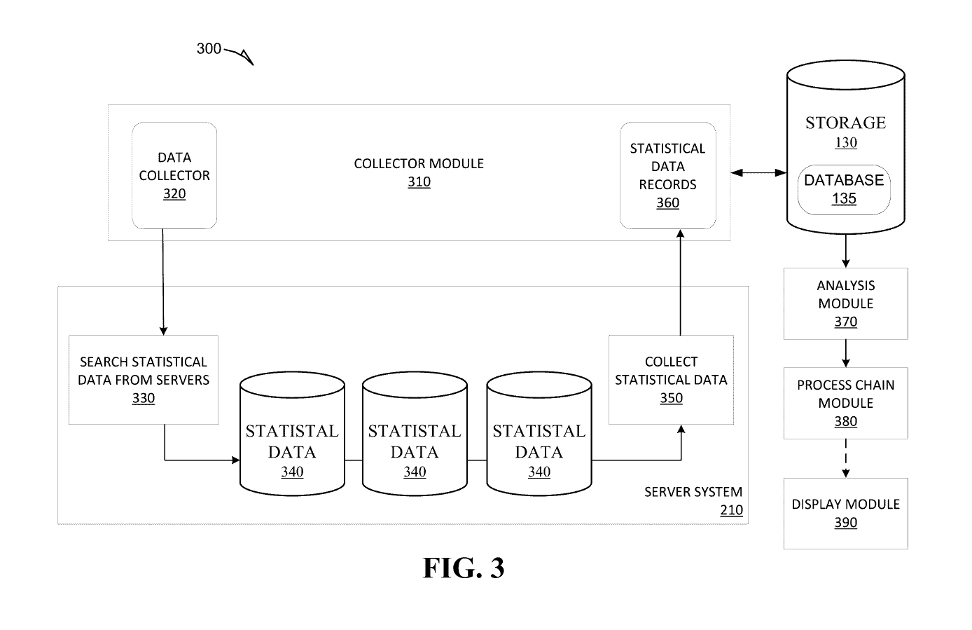

FIG. 3 is a block diagram of a process chain discovery system 300, consistent with some embodiments, configured to discover a process chain for a user session that includes communications with other user sessions across distinct communication channels. The elements in FIG. 3 include elements from FIG. 1 and FIG. 2, which elements are labeled with the same identifiers. The data transfers depicted in FIG. 3 may occur over a network like network 105 of FIG. 1, as explained above.

System 300 includes a collector module 310 which may be invoked by a process chain discovery tool used by an administrator of system 300. The collector module 310 may, based on user input from the administrator, access a context identifier (e.g., root context identifier (ID)) associated with an initial (e.g., launcher) application program executed during an online user session 150A of a user 110A at a server 140A. The collector module 310 may access one or more attributes of the user 110A and one or more attributes of the online user session 150A from the initial application program (for example, a user ID, client number, a session begin timestamp, or a session end timestamp). The collector module 310 can then invoke a function data collector 320 to perform a search 330 of one or more data sources of statistical data 340 associated with each of the servers 140 of server system 210 (for example, ABAP channel (APC and AMC) specific data). The search 330 can focus on statistical data 340 associated with at least one of the one or more attributes of the user 110A or of the one or more attributes of the online user session 150A. The data collector 320 may filter the amount of searched statistical data 340 that is eventually collected by using the context identifier from the initial application to perform a collection 350 of searched statistical data 340 to generate statistical data records 360 that each comprise a portion of the searched statistical data 340 that is associated with the context identifier or otherwise relevant to the context identifier. The statistical data records 360 may be stored in a connected storage, such as storage 130 with database 135, for convenient access by other components of system 300.

System 300 also includes an analysis module 370 configured to analyze each of the collected statistical data records 360 and log all communication protocols (e.g., HTTP, AMC, APC, etc.) associated with each of the statistical data records 360. The analysis module 370 can then select a specific monitoring tool for a detailed analysis of each of the collected statistical data records 360. The analysis module 370 can make the selection of the specific monitoring tool based on at least one of the logged communication protocols associated with each of the collected statistical data records 360. The selected monitoring tools can be protocol-specific monitoring tools (e.g., SAP ABAP Trace) configured to perform an analysis of data associated with a specific communication protocol (e.g., statistical data records 360 with associated logged AMC or APC protocols). In this way, the analysis module 370 can perform functional logging to identify function errors associated with the user session 150A, for example, based on a status code record element of a collected statistical data record 360. The analysis module 370 can also perform performance logging to identify low component performance during a portion of the online user session 150A, for example, based on a comparison of a “component processing time” data record element of each of the collected statistical data records 360 to reference data associated with the relevant component by the respective selected monitoring tool for each of the collected statistical data records 360. The analysis module 370 can also display at least one error message in a user interface (e.g., on client device 120A of user 110A) where the at least one error message can correspond to (and explain in simple language) each of the identified function errors or instances of low component performance during the user session 150A. The display functionality may be performed by a separate display module 390.

System 300 also includes a process chain module 380 configured to parse a first statistical data record 360 (e.g., associated with an initial “action” of the initial launcher application program) to identify one or more first data record elements that may be indicative of related statistical data records 360. One such data record element could be a connection identifier that identifies peers in a connection (e.g., client device 120A and server 140A) as explained more fully below. The process chain module 380 can discover a process chain for user session 150A by mapping the first statistical data record 360 to one or more second statistical data records 360 based on at least one of the identified first data record elements. For example, the one or more second statistical data records 360, including data record elements associated with either the connection identifier or with a peer component identified by the connection identifier, may be mapped to the first statistical data record 360. The process chain module 380 can fully discover the process chain for user session 150A by performing the same mapping steps for each of the one or more second statistical data records 360. The process chain module 380 can parse each second statistical data record 360 to identify one or more second data record elements and map each second statistical data record 360 to one or more third statistical data records 360 based on at least one of the identified second data record elements.

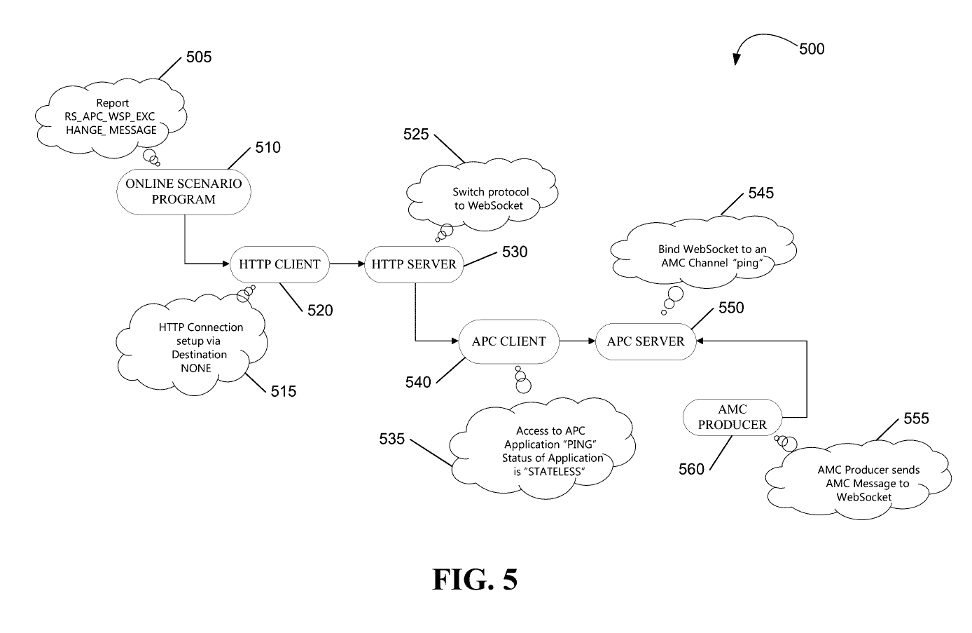

The process chain module 380 can then construct a process chain for the online user session 150A based on the above-described mappings (e.g., based on related sequences of mapped statistical data records 360) and display the process chain graphically (e.g., as described below with respect to FIG. 5) in the user interface of client device 120A. The display functionality may be performed by a separate display module 390. In embodiments, the process chain for the online user session 150A may comprise a sequence of used elements or processes of server system 210 including at least one of: a communication protocol, a communication sub-protocol, an application name, an application state, an application action, a business scenario, a hardware component or a hardware component action.

In an embodiment, the data record elements of the statistical data records 360 each comprise at least one connection identifier that identifies peers in a connection (for example, client device 120A and server 140A, client device 120B and server 140B, or server 140A and server 140B). The process chain module 380 can then map the first statistical data record 360 to one or more second statistical data records 360 based on an identified first data record element comprising a connection identifier that identifies a connection between a communication component (e.g., client device 120A) associated with the first statistical data record 360 and a communication component (e.g., server 140A) associated with at least one second statistical data record 360. Furthermore, for each of the at least one second statistical data record 360, the process chain module 380 can map the second statistical data record 360 to one or more third examined data records based on an identified second data record element of the second statistical data record 360 comprising a connection identifier that identifies a connection between a communication component associated with the second data record (e.g., server 140A) and a communication component associated with the one or more third examined data records (e.g., server 140B). In this way, the process chain module 380 can track the flow of messages between user session 150A of user 110A and user session 150B of user 110B across messaging channel 220 and push channels 230A and 230B to provide an administrative user (e.g., user 110A) with a graphical representation of the process chain for user session 150A in a way that allows the administrative user to appreciate the context, message flow, and interrelationships between separate user sessions 150 in server system 210.

In embodiments, the collected statistical data records 360 may include at least one of: a RFC data record, a HTTP data record, an advanced business AMC data record or an advanced business APC data record.

In an embodiment, the collected statistical data records 360 may include at least one RFC data record that includes at least one data record element comprising: a name of an RFC function module; a user name in an RFC server session; a client of the user in the RFC server session; a name of the application server that processed the RFC function module; a caller name that may comprise a system ID, a user name, a client name or a program name; a timestamp; a root context ID that was generated in the initial launcher program and propagated to all components in the process chain; or a connection identifier that identifies the peers in a connection, for example, between RFC client and RFC server part or between RFC caller program and RFC called program.

In an embodiment, the collected statistical data records 360 may include at least one HTTP data record that includes at least one data record element comprising: an origin uniform resource locator (URL) path from an HTTP request; a user name in an HTTP server session; a client of the user in the HTTP server session; a name of the application server that processed the HTTP request; a caller name that may comprise a system ID, a user name, a client name, or a program name; a status code to identify function errors; a caller name that may comprise a system ID, a user ID, a client ID, or a program ID; a timestamp; a root context ID that was generated in the initial launcher program and propagated to all components in the process chain; or a connection identifier that identifies the peers in an HTTP connection.

In an embodiment, the collected statistical data records 360 may include at least one of an advanced business APC data record that includes at least one data record element comprising: an APC application identifier; an APC type (e.g., client or server part); a connection type (e.g., WebSocket(s), Transmission Control Protocol(s) (TCP)); a host, port, and service path of an APC application; an action name (e.g., name of implemented events in maintained ABAP classes in a transaction for the APC application identifier); a caller program, a status code to identify function errors; a timestamp; a processing time for a component; a root context ID that was generated in the initial launcher program and propagated to all components in the process chain; or a connection identifier that identifies the peers in a connection.

In an embodiment, the collected statistical data records 360 may include at least one an advanced business AMC data record that includes at least one data record element comprising: an AMC application identifier; an AMC type (e.g., consumer or provider parts); a channel attribute (e.g., channel ID, scope, message type, channel extension ID); a consumer name that may comprise a system ID, a user ID, or a client ID; a provider name that may comprise a user ID or a client ID; an APC application server identifier (e.g., where the AMC provider part has been executed); an action name; a caller program and a status code to identify function errors; a processing time for a component; a timestamp; or a connection identifier that identifies the peers in a connection.

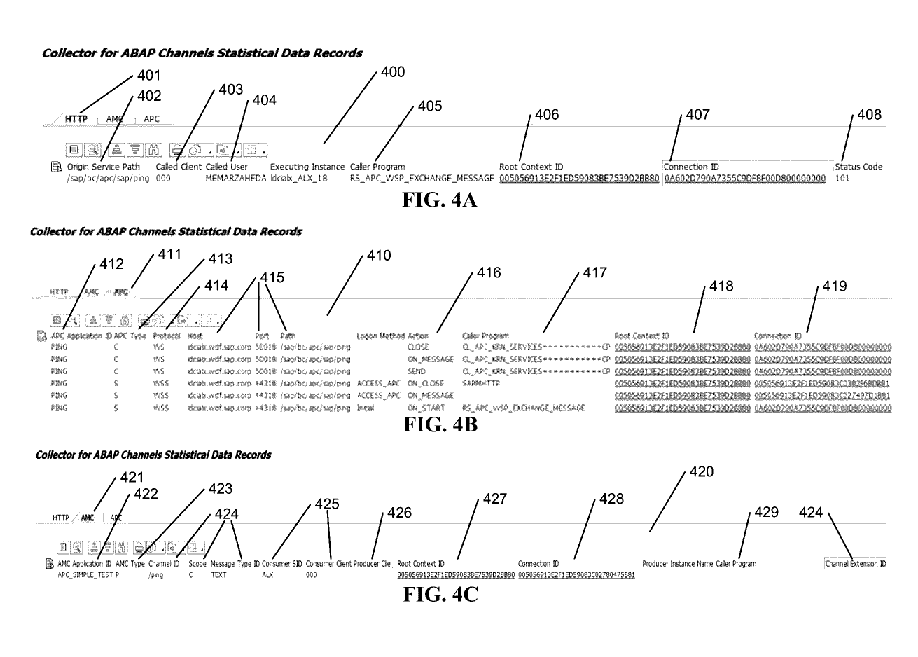

FIGS. 4A, 4B and 4C are example data records and data record elements, consistent with some embodiments, in the form of database tables. The example data records may comprise the records examined to discover a process chain for a user session 150A as described above.

In FIG. 4A, a first statistical data record 400 comprises an HTTP record (as indicated by tab 401) with identified data record elements such as: an origin URL path 402 from an HTTP request (the node/sap/bc/apc/sap/ping); a user name 404 in an HTTP server session; a client 403 of the user in the HTTP server session; a name of the caller program 405 that submitted the HTTP request; a root context ID 406 extracted from the caller program 405; a connection identifier 407, which can be used to identify the peers in the HTTP connection; and a status code 408 with value “101,” which shows the communication protocol switch from HTTP to WebSocket protocol.

In FIG. 4B, a set of second statistical data records 410 comprise APC data records (as indicated by tab 411), which have been mapped to the first statistical data record 400. Each of the statistical data records 410 includes identified data record elements such as: an APC application identifier 412 (e.g., “PING”); an APC type 413 (e.g., client or server part); a protocol 414 (e.g., connection type such as WebSocket(s) or TCP(s)); a host, port, and service path 415 of an APC application; an action name 416 (e.g., for the statistical data records 410, the list of actions includes the usage of following events (actions): SEND (send message), ON_MESSAGE (receive message) or CLOSE (close connection)); a caller program 417 (e.g., “RS_APC_WSP_EXCHANGE_MESSAGE”); a root context ID 418 that was generated in the initial launcher program and propagated to all components in the process chain; and a connection identifier 419 that identifies the peers in a connection. The APC statistical data records 410 show client and server components (e.g., type 413) for the WebSocket connections.

In FIG. 4C, a third statistical data record 420 comprises an AMC data record (as indicated by tab 421) which has been mapped to one of the second statistical data records 410. The statistical data record 420 includes identified data record elements such as: an AMC application identifier 422 (e.g., “APC_SIMPLE_TEST”); an AMC type 423 (e.g., consumer or provider parts); channel attributes 424 including a: channel ID, scope, message type, and channel extension ID; a consumer name 425 that comprises a consumer ID and a client ID; a provider name 426 that comprises a producer client ID; a caller program 429; a root context ID 427 that was generated in the initial launcher program and propagated to all components in the process chain; and a connection identifier 428 that identifies the peers in a connection. The same connection identifier (e.g., “connection_id”) between APC client and server identifies the connection partner for the action “ON_START” from the bottom record 410 of FIG. 4B and is used to map statistical data record 420 to the said bottom record 410 of FIG. 4B. The used connection type (WS (WebSocket) or WSS (Secure WebSocket) in this case) displays the communication protocol used. The following events (actions) have been performed on the APC server part: ON_START, ON_MESSAGE (receive message), or ON_CLOSE (reaction on close action on the APC client part).

FIG. 5 is an example graphical display 500 of a process chain for a user session 150A of a user 110A of a client device 120A of server 140A of server system 210, consistent with some embodiments, for viewing and analysis by an administrative user (e.g., user 110A). The example process chain is based on the example statistical data records 400, 410, and 420 of FIG. 4 as used to discover a process chain for a user session 150A as described above.

In bubble 505 it is reported that the initial online scenario program 510 that launched the user session 150A was program: RS_APC_WSP_EXCHANGE_MESSAGE (caller program 405 of FIG. 4A), which was started in dialog mode. In bubble 515 it is reported that the connection to HTTP client 520 was setup via “Destination=None.” In bubble 525 it is reported that the connection to HTTP server 530 involved a protocol switch from HTTP to WebSocket (see status code 101 of FIG. 4A). In bubble 535 it is reported that the connection to the APC client 540 was established via access to APC application “PING” (APC application identifier 412 of FIG. 4B) with an application status of “Stateless.” In bubble 545 it is reported that the connection to the APC server 550 was established by binding a WebSocket to an AMC channel “ping” (Protocol 414 of FIG. 4B). In bubble 555 it is reported that the connection to the AMC producer 560 is based on the AMC producer 560 sending an AMC message to the bound WebSocket.

After the graphical display 500 of a process chain for a user session 150A discovers that a WebSocket has been bound to an AMC channel “ping,” it may also be discovered that APC Client events (Actions 416 of FIG. 4B) “SEND,” “ON_MESSAGE,” and “CLOSE” have been called and that APC Server was called successfully (no error found when calling ON_START event). It may further be discovered that APC Server has received the sent messages from APC client and did not send any messages to APC client. Additionally, it may be discovered that APC Server has reacted correctly to APC client event “CLOSE” and closed the WebSocket. Lastly, it may be discovered that APC server has bound the WebSocket to channel “/ping” to get the messages from the AMC producer (via matching of a connection ID 419 of FIG. 4B to the connection ID 428 of FIG. 4C).

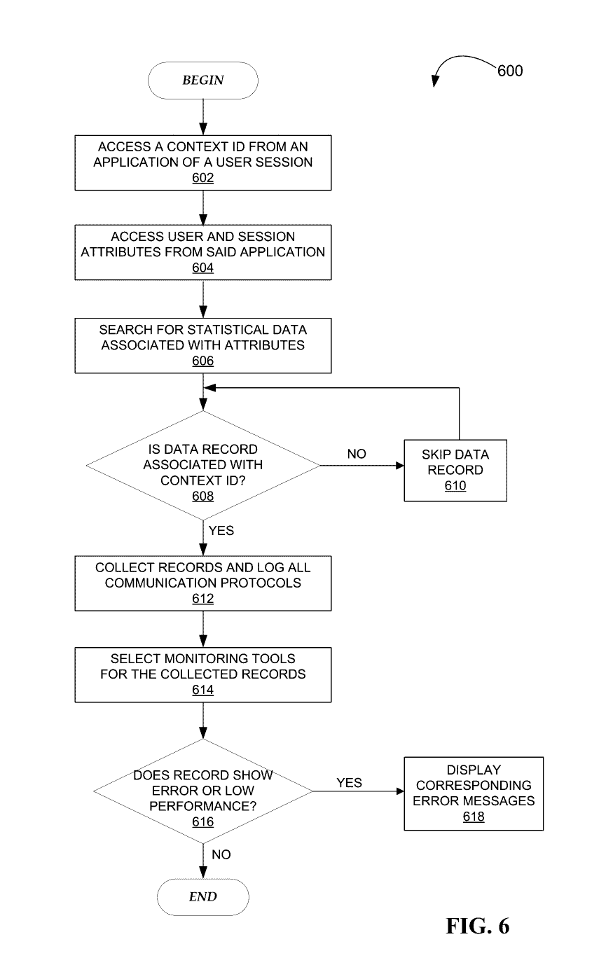

FIG. 6 is a flow diagram of a method, consistent with some embodiments, for discovering function errors or low component performance during a user session that includes communications with other user sessions across distinct communication channels. The method 600 will be described with respect to the elements of FIGS. 1-3 as described above.

At operation 602, the collector module 310 may access a context identifier associated with an initial application program executed during an online session 150A of a user 110A of a client device 120A of server 140A of a server system 210. At operation 604, the collector module 310 may access one or more attributes of the user 110A and one or more attributes of the online user session 150A from the initial application program that was used to launch the user session 150A. At operation 606, the collector module 310 may invoke function data collector 320 to search one or more data sources of statistical data 340 to find statistical data 340 associated with at least one of the one or more attributes of the user 110A or of the one or more attributes of the online user session 150A. If it is determined, at operation 608 by data collector 320, that a portion of the searched statistical data 340 is not associated with or otherwise relevant to the context identifier of the initial application (e.g., based on comparison to reference data) then, at operation 610, the said portion of the searched statistical data is simply skipped (e.g., not collected). If there is at least one portion of the searched statistical data 340 that is associated with or otherwise relevant to the context identifier of the initial application, then, at operation 612, the collector module 310 may invoke function data collector 320 to collect the portions of the searched statistical data 340 that are associated with or otherwise relevant to the context identifier to generate statistical data records 360 that each comprise a portion of the searched statistical data 340 that is associated or relevant to the context identifier and invoke analysis module 370 to analyze each of the statistical data record 360 and log all communication protocols (e.g., HTTP, AMC, APC, etc.) associated with each of the statistical data records 360. The statistical data records 360 may be stored in a connected storage, such as storage 130 with a database 135.

At operation 614, the analysis module 370 can then select a specific monitoring tool for a detailed analysis of each of the collected statistical data records 360. The analysis module 370 can make the selection of the specific monitoring tool based on at least one of the logged communication protocols associated with each of the collected statistical data records 360. At operation 616, the analysis module 370 can perform functional logging and performance logging based on the collected statistical data records 360. The functional logging can identify function errors associated with the user session 150A, for example, based on a status code record element of a collected statistical data record 360. The performance logging can identify low component performance during a portion of the online user session 150A, for example, based on a comparison of a “component processing time” data record element of each of the collected statistical data records 360 to reference data associated with the relevant component by the respective selected monitoring tool for each of the collected statistical data records 360. At operation 618, if a function error or low component performance is detected, then the analysis module 370 may display at least one error message in a user interface (e.g., on client device 120A of user 110A) where the at least one error message can correspond to (and explain in simple language) each of the identified function errors or instances of low component performance during the user session 150A. The display functionality may be performed by a separate display module 390. If no other function errors or low component performance are detected, then the method 600 ends.

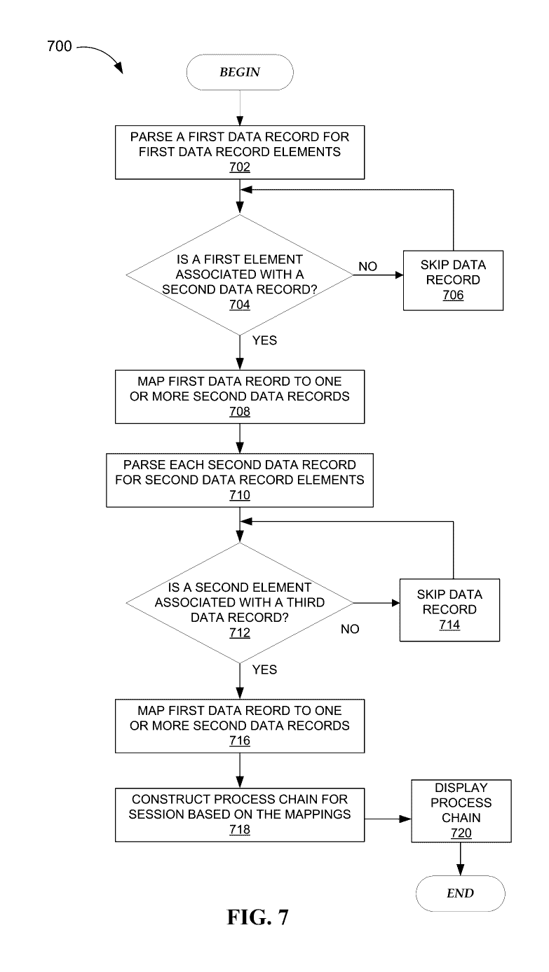

FIG. 7 is a flow diagram of a method 700, consistent with some embodiments, for discovering a process chain for a user session that includes communications with other user sessions across communication channels. At operation 702, process chain module 380 may parse a first statistical data record 360 (e.g., associated with an initial “action” of the initial launcher application program) to identify one or more first data record elements that may be indicative of related statistical data records 360. The process chain module 380 can discover a process chain for user session 150A by mapping the first statistical data record 360 to one or more second statistical data records 360 based on at least one of the identified first data record elements. At operation 704, each of the at least one first data record elements are examined to determine whether they indicate a relationship with a second statistical data record 360, for example, based on a connection identifier. At operation 706, second statistical data records 360 that are not determined to be related to the first statistical data record 360 are skipped over and not mapped. At operation 708, second statistical data records 360 that are determined to be related to the first statistical data record 360 are mapped to the first statistical data record 360, for example, based on including at least one second data record element that is associated with the at least one first data record element. The process chain module 380 can then fully discover the process chain for user session 150A by performing the same mapping steps 702-708 for each of the one or more second statistical data records 360. At operation 710, the process chain module 380 may parse each second statistical data record 360 to identify one or more second data record elements that may be indicative of related statistical data records 360. At operation 712, each of the one or more second data record elements are examined to determine whether they indicate a relationship with a third statistical data record 360. At operation 714, third statistical data records 360 that are not determined to be related to one of the one or more second statistical data records 360 are skipped over and not mapped. At operation 716, third statistical data records 360 that are determined to be related to one of the one or more second statistical data records 360 are mapped to the respective second statistical data record 360 with which they are associated.

At operation 718, the process chain module 380 can then construct a process chain for the online user session 150A based on the above-described mappings (e.g., based on related sequences of mapped statistical data records 360). In embodiments, the process chain for the online user session 150A may comprise a sequence of used elements or processes of server system 210 including at least one of: a communication protocol, a communication sub-protocol, an application name, an application state, an application action, a business scenario, a hardware component, or a hardware component action. At operation 720, the process chain module 380 can then display the process chain graphically (e.g., as described above with respect to FIG. 5) in a user interface of client device 120A of user 110A. As noted above, the display functionality may be performed by a separate display module 390.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein may, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or a server farm), while in other example embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments can be implemented in digital electronic circuitry, or in computer hardware, firmware, software, or combinations of these. Example embodiments can be implemented using a computer program product. e.g., a computer program tangibly embodied in an information carrier. e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware can be a design choice. Below are set out hardware (e.g., machine) and software architectures that can be deployed, in various example embodiments.

### Machine Architecture and Machine-Readable Medium

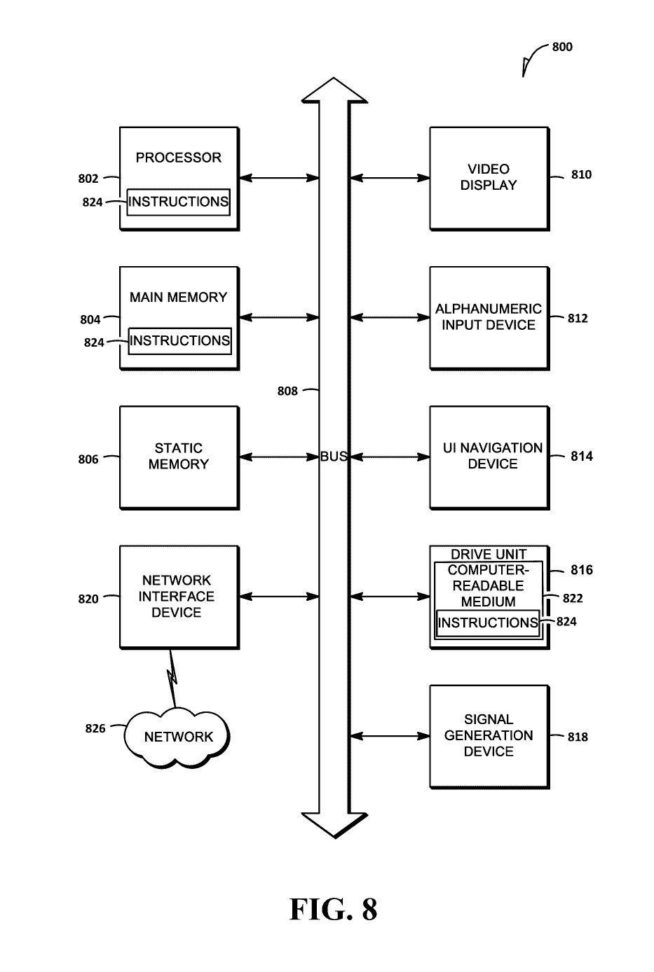

FIG. 8 is a block diagram of a machine in the example form of a computer system 800 within which instructions 824 for causing the machine to perform any one or more of the methodologies discussed herein can be executed. In alternative embodiments, the machine can operate as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a PC, a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 can further include a video display unit 810 (e.g., a liquid crystal display (LCD) or a cathode ray tube (CRT)). The computer system 800 can also include an alphanumeric input device 812 (e.g., a keyboard or a touch-sensitive display screen), a user interface (UI) navigation device 814 (e.g., a mouse), a drive unit 816, a signal generation device 818 (e.g., a speaker), and a network interface device 820.

### Machine-Readable Medium

The disk drive unit 816 includes a computer-readable medium 822 on which is stored one or more sets of data structures and instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, the main memory 804 and the processor 802 also constituting machine-readable media

While the computer-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions (e.g., instructions 824) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and other ROM disks.

### Transmission Medium

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions (e.g., instructions 824) for execution by the machine, and includes digital or analog communications signals or other media to facilitate communication of software.

### Example Mobile Device

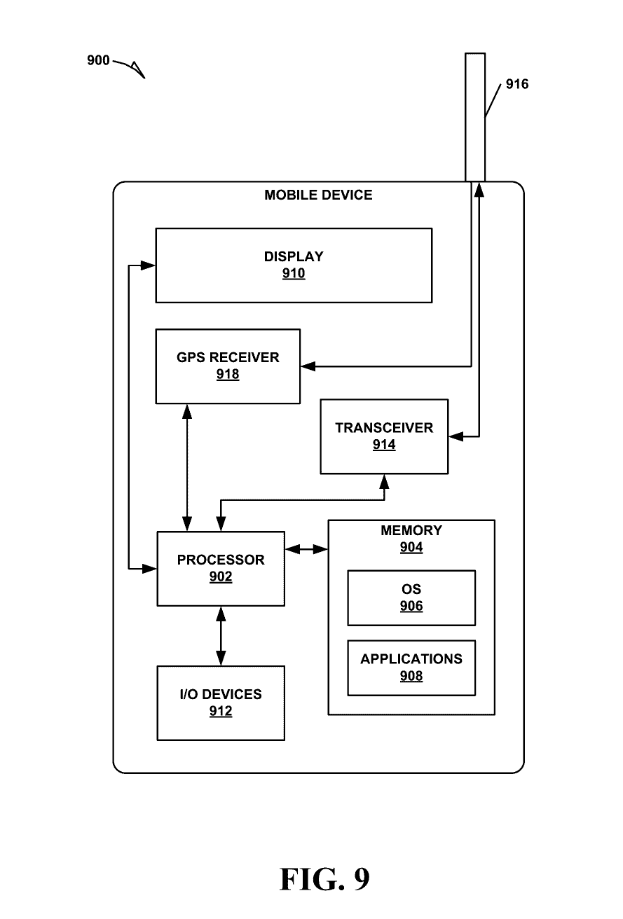

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or another type of memory, is typically accessible to the processor 902. The memory 904 may be adapted to store an operating system (OS) 906, as well as applications 908, such as a mobile location-enabled application that may provide location-based services (LBSs) to a user. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive Global Positioning System (GPS) signals.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents.

1. A system comprising:
at least one hardware processor;
a collector module implemented by the at least one processor and configured to:
access a context identifier associated with an initial application program executed during an online session of a user;
access one or more attributes of the user and one or more attributes of the online session from the initial application program;
search one or more data sources to find statistical data associated with at least one of the one or more attributes of the user or of the one or more attributes of the online session; and
collect data records from the one or more data sources, the data records each comprising a portion of the statistical data that is associated with the context identifier;
an analysis module implemented by the at least one processor and configured to:
analyze each of the collected data records to log communication protocols associated with each of the collected data records;
select a monitoring tool for each of the collected data records, the selection being based on at least one of the communication protocols associated with each of the collected data records;
identify function errors or low component performance during a portion of the online session, the identification being based on a comparison of each of the collected data records to reference data by the respective selected monitoring tool; and
display at least one error message in a user interface, the at least one error message being based on the identified function errors or low component performance.

2. The system of claim 1, further comprising:
a process chain module implemented by the at least one processor and configured to:
parse a first collected data record to identify one or more first data record elements;
map the first collected data record to one or more second collected data records based on at least one of the identified first data record elements;
for each of the one or more second collected data records:
parse the second data record to identify one or more second data record elements; and
map the second data record to one or more third collected data records based on at least one of the identified second data record elements;
construct a process chain for the online session based on the mappings; and
display the process chain graphically in the user interface.

3. The system of claim 2, wherein the process chain for the online session comprises a sequence of used elements or processes including at least one: communication protocol; communication sub-protocol; application name; application state; application action; business scenario; hardware component; or hardware component action.

4. The system of claim 2, wherein the one or more first data record elements and the one or more second data record elements each comprise at least one connection identifier and the process chain module is further configured to:
map the first data record to one or more second examined data records based on an identified first data record element comprising a connection identifier that identifies a connection between a communication component associated with the first data record and a communication component associated with the one or more second examined data records; and
for each of the one or more second examined data records:
map the second data record to one or more third examined data records based on an identified second data record element comprising a connection identifier that identifies a connection between a communication component associated with the second data record and a communication component associated with the one or more third examined data records.

5. The system of claim 4, wherein the at least one found data record comprises a remote function call (RFC) data record, a hypertext transfer protocol (HTTP) data record, an advanced business application programming messaging channel (AMC) data record, or an advanced business application programming push channel (APC) data record.

6. The system of claim 5, wherein the at least one found data record comprises a RFC data record that includes at least one data record element comprising: a name of an RFC function module; a user name in an RFC server session; a client of the user in the RFC server session; a name of the application server that processed the RFC function module; a caller name; name of RFC destination used for RFC call; a timestamp; or a connection identifier that identifies the peers in a connection.

7. The system of claim 5, wherein the at least one found data record comprises a HTTP data record that includes at least one data record element comprising: an origin uniform resource locator (URL) path from an HTTP request; a user name in an HTTP server session; a client of the user in the HTTP server session; a name of the application server that processed the HTTP request; a caller name; a status code to identify function errors; a timestamp; or a connection identifier that identifies the peers in an HTTP connection.

8. The system of claim 5, wherein the at least one found data record comprises an advanced business APC data record that includes at least one data record element comprising: an APC application identifier; an APC type; a connection type; a host, port, and service path of an APC application; an action name; a caller program, a status code to identify function errors; a processing time for a hardware component; a timestamp; or a connection identifier that identifies the peers in a connection.

9. The system of claim 5, wherein the at least one found data record comprises an advanced business AMC data record that includes at least one data record element comprising: an AMC application identifier; an AMC type; a channel attribute; a consumer name; a provider name; an AMC application server identifier; an action name; a caller program, a status code to identify function errors; a processing time for a hardware component; a timestamp; or a connection identifier that identifies the peers in a connection.

10. A method comprising:
accessing a context identifier associated with an initial application program executed during an online session of a user;
accessing one or more attributes of the user and one or more attributes of the online session from the initial application program;
searching one or more data sources to find statistical data associated with at least one of the one or more attributes of the user or of the one or more attributes of the online session; and
collecting data records from the one or more data sources, the data records each comprising a portion of the statistical data that is associated with the context identifier;
analyzing each of the collected data records to log communication protocols associated with each of the collected data records;
selecting a monitoring tool for each of the collected data records, the selection being based on at least one of the communication protocols associated with each of the collected data records;
identifying function errors or low component performance during a portion of the online session, the identification being based on a comparison of each of the collected data records to reference data by the respective selected monitoring tool; and
displaying at least one error message in a user interface, the at least one error message being based on the identified function errors or low component performance.

11. The method of claim 10, further comprising:
parsing a first examined data record to identify one or more first data record elements;
mapping the first examined data record to one or more second examined data records based on at least one of the identified first data record elements;
for each of the one or more second examined data records:
parsing the second data record to identify one or more second data record elements; and
mapping the second data record to one or more third examined data records based on at least one of the identified second data record elements;
constructing a process chain for the online session based on the mappings; and
displaying the process chain graphically in a user interface.

12. The method of claim 11, wherein the process chain for the online session comprises a sequence of used elements or processes including at least one of: communication protocol; communication sub-protocol; application name: application state; application action; business scenario; hardware component; or hardware component action.

13. The method of claim 11, wherein the one or more first data record elements and the one or more second data record elements each comprise a connection identifier and the method further comprises:
mapping the first data record to one or more second examined data records based on an identified first data record element comprising a connection identifier that identifies a connection between a communication component associated with the first data record and a communication component associated with the one or more second examined data records; and
for each of the one or more second examined data records:
mapping the second data record to one or more third examined data records based on an identified second data record element comprising a connection identifier that identifies a connection between a communication component associated with the second data record and a communication component associated with the one or more third examined data records.

14. The method of claim 10, wherein the at least one found data record comprises a remote function call (RFC) data record, a hypertext transfer protocol (HTTP) data record, an advanced business application programming messaging channel (AMC) data record, or an advanced business application programming push channel (APC) data record.

15. The method of claim 14, wherein the at least one found data record comprises a RFC data record that includes at least one data record element comprising: a name of an RFC function module; a user name in an RFC server session; a client of the user in the RFC server session; a name of the application server that processed the RFC function module; a caller name; name of RFC destination used for RFC call; a timestamp; or a connection identifier that identifies the peers in a connection.

16. The method of claim 14, wherein the at least one found data record comprises a HTTP data record that includes at least one data record element comprising: an origin uniform resource locator (URL) path from an HTTP request; a user name in an HTTP server session; a client of the user in the HTTP server session; a name of the application server that processed the HTTP request; a caller name; a status code to identify function errors; a timestamp; or a connection identifier that identifies the peers in an HTTP connection.

17. The method of claim 14, wherein the at least one found data record comprises an advanced business APC data record that includes at least one data record element comprising: an APC application identifier; an APC type; a connection type; a host, port, and service path of an APC application; an action name; a caller program, a status code to identify function errors; a processing time for a hardware component; a timestamp; or a connection identifier that identifies the peers in a connection.

18. The method of claim 14, wherein the at least one found data record comprises an advanced business AMC data record that includes at least one data record element comprising: an AMC application identifier; an AMC type; a channel attribute; a consumer name; a provider name; an AMC application server identifier; an action name; a caller program, a status code to identify function errors; a processing time for a hardware component; a timestamp; or a connection identifier that identifies the peers in a connection.

19. A non-transitory machine-readable storage medium storing instructions which, when executed by at least one processor of a machine, cause the machine to perform operations comprising:
accessing a context identifier associated with an initial application program executed during an online session of a user;
accessing one or more attributes of the user and one or more attributes of the online session from the initial application program;
searching one or more data sources to find statistical data associated with at least one of the one or more attributes of the user or of the one or more attributes of the online session; and
collecting data records from the one or more data sources, the data records each comprising a portion of the statistical data that is associated with the context identifier;
analyzing each of the collected data records to log communication protocols associated with each of the collected data records;
selecting a monitoring tool for each of the collected data records, the selection being based on at least one of the communication protocols associated with each of the collected data records;
identifying function errors or low component performance during a portion of the online session, the identification being based on a comparison of each of the collected data records to reference data by the respective selected monitoring tool; and
displaying at least one error message in a user interface, the at least one error message being based on the identified function errors or low component performance.

20. The machine-readable storage medium of claim 19, the operations further comprising:
parsing a first examined data record to identify one or more first data record elements;
mapping the first examined data record to one or more second examined data records based on at least one of the identified first data record elements;
for each of the one or more second examined data records:
parsing the second data record to identify one or more second data record elements; and
mapping the second data record to one or more third examined data records based on at least one of the identified second data record elements;
constructing a process chain for the online session based on the mappings; and
displaying the process chain graphically in a user interface.
